(19) United States
(12) Patent Application Publication
(10) Pub. No.: US 2026/0264396 A1
(43) Pub. Date: Sep. 10, 2026

(54) PRINTING APPARATUS AND CONTROL METHOD

(71) Applicant: CANON KABUSHIKI KAISHA, Tokyo (JP)

(72) Inventors: YUHEI OIKAWA, Kanagawa (JP); KOHEI SATO, Kanagawa (JP); SACHIKO YAMAUCHI, Kanagawa (JP); KAZUKI TAKAHASHI, Tokyo (JP); KYOSUKE DEGUCHI, Kanagawa (JP); ATSUHIKO MASUYAMA, Kanagawa (JP); TAKAFUMI ITO, Kanagawa (JP)

(21) Appl. No.: 19/535,319

(22) Filed: Feb. 10, 2026

(30) Foreign Application Priority Data
Mar. 5, 2025 (JP) 2025-034515

(51) Int. Cl. B41J 2/045; B41J 2/14; B41J 2/175; B41J 2/18

(52) U.S. Cl. CPC B41J 2/04563; B41J 2/0454; B41J 2/0457; B41J 2/0458; B41J 2/04588; B41J 2/04591; B41J 2/14153; B41J 2/175; B41J 2/18

(57) ABSTRACT

A printing apparatus includes: an element substrate provided with a print element array, heating elements, and sensors; a first determination unit; a second determination unit; a third determination unit; and a drive unit. At least one of the heating elements and at least one of the sensors are provided in each of a plurality of divided regions. The first determination unit determines a first drive intensity of the heating element, the second determination unit determines a correction value for correcting the first drive intensity, the third determination unit determines a second drive intensity of the heating element based on the correction value, and the drive unit drives the heating element according to the second drive intensity. The correction value is determined based on the temperature detected by the sensor and a position of each of the divided regions.

### BACKGROUND

### Field of the Technology

The present disclosure relates to a printing apparatus and a control method.

### Description of the Related Art

There is a printing apparatus that prints an image on a print medium and that includes a print head generally including an element substrate having multiple print elements configured to generate thermal energy for ejecting liquids. In some cases, in this type of printing apparatus, the element substrate is divided into multiple regions, a heating element is provided in each of these regions (divided regions), and a drive intensity of the heating element in each of the divided regions is adjusted to perform control of adjusting a temperature of the element substrate to a target temperature suitable for printing.

Japanese Patent Laid-Open No. 2020-032696 discloses a printing apparatus that: determines a drive intensity of a heating element in each of divided regions; determines a correction value for correcting the drive intensity; and determines a corrected drive intensity by adding up the drive intensity and the correction value.

In the printing apparatus (hereinafter, referred to as “conventional technique”) of Japanese Patent Laid-Open No. 2020-032696, although the correction value for correcting the drive intensity is adjusted depending on the position of the divided region, the correction value is not adjusted depending on the target temperature. Specifically, in the divided region associated with the correction value of a direction in which the drive intensity is increased such as the divided region located in an end portion of the element substrate, this correction value of the direction in which the drive intensity is increased is used also in a situation where the temperature is slightly lower than the target temperature. Accordingly, in the conventional technique, the temperature of the element substrate sometimes exceeds the target temperature in the case where the temperature of the element substrate reaches the target temperature once, then slightly falls, and is made to return to the target temperature again.

### SUMMARY

The present disclosure is to provide a printing apparatus that can perform temperature control with high reliability.

A printing apparatus includes an element substrate provided with a print element array formed of a plurality of print elements configured to eject a liquid to a print medium, heating elements configured to heat the liquid, and sensors configured to detect temperatures, at least one of the heating elements and at least one of the sensors are provided in each of a plurality of divided regions obtained by dividing the element substrate into a plurality of regions, the printing apparatus further has: a first determination unit configured to determine a first drive intensity for the heating element based on the temperature detected by the sensor for each of the divided regions; a second determination unit configured to determine a correction value for correcting the first drive intensity for each of the divided regions; a third determination unit configured to determine a second drive intensity by correcting the first drive intensity based on the correction value for each of the divided regions; and a drive unit configured to drive the heating element according to the second drive intensity for each of the divided regions, and the second determination unit determines the correction value based on the temperature and a position of each of the divided regions.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating an example of a printing apparatus in one embodiment;

FIG. 2 is a block diagram illustrating an example of a control system in one embodiment;

FIG. 3 is a block diagram illustrating an example of a print control unit in one embodiment;

FIG. 4 is a schematic perspective diagram illustrating an example of a print head in one embodiment;

FIG. 5A is a schematic bottom diagram of a print element substrate adoptable to one embodiment;

FIG. 5B is an enlarged diagram of a region 500a in FIG. 5A;

FIG. 5C is an enlarged diagram of a region 500b in FIG. 5A;

FIG. 6 is a schematic plan diagram of the print element substrate in one embodiment;

FIG. 7 is a cross-sectional diagram of a VII-VII line in FIG. 5A;

FIG. 8A is a diagram explaining temperature control of an ejection port surface of the print element substrate;

FIG. 8B is a schematic bottom diagram of a substrate;

FIG. 9 is a flowchart illustrating processes for maintaining a target temperature;

FIG. 10 is a diagram illustrating region numbers of divided regions;

FIG. 11 is a diagram illustrating an example of a first table;

FIG. 12 is a diagram illustrating an example of a second table;

FIG. 13 is a graph illustrating a relationship between time and voltage of drive of sub-heaters;

FIG. 14A is a diagram illustrating an example of a table of a conventional technique;

FIG. 14B is a diagram illustrating an example of a graph illustrating a temperature change from start of temperature adjustment to reaching of the target temperature;

FIG. 14C is a diagram illustrating an example of a graph illustrating a temperature change after reaching of the target temperature;

FIG. 15A is a diagram illustrating another example of the table of the conventional technique;

FIG. 15B is a diagram illustrating an example of a graph illustrating a temperature change after reaching of the target temperature;

FIG. 15C is a diagram illustrating an example of a graph illustrating a temperature change from a normal temperature to reaching of the target temperature;

FIG. 16A is a graph illustrating a temperature change in each of the divided regions in one embodiment;

FIG. 16B is a graph illustrating a temperature change after the temperature of each divided region reaches the target temperature in one embodiment;

FIG. 17A is a diagram of a table used in the case where a temporal drive intensity of the sub-heaters is selected in a comparative example;

FIG. 17B is a diagram of a table prepared to directly set an actual drive intensity of the sub-heaters without setting of the temporal drive intensity;

FIG. 18A is a diagram illustrating a table adoptable to the case where the temporal drive intensity of the sub-heaters is selected in one embodiment;

FIG. 18B is a diagram illustrating a table used in the case where the correction value of the sub-heaters is selected in one embodiment;

FIG. 19 is an explanatory diagram of temperature control of the print element substrate in one embodiment;

FIG. 20 is a diagram illustrating an example of a third table;

FIG. 21A is a diagram illustrating a table used to select the correction value of the temporal drive intensity in a comparative example; and

FIG. 21B is a diagram illustrating a table used to select the correction value of the temporal drive intensity in another comparative example.

### DESCRIPTION OF THE EMBODIMENTS

### First Embodiment

### <Printing Apparatus 100>

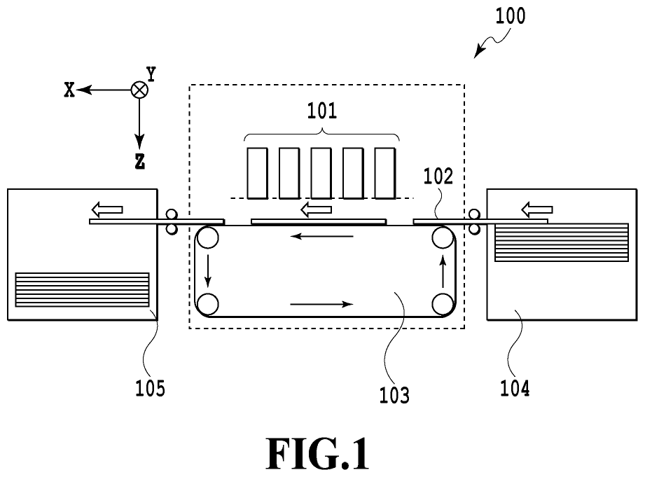

FIG. 1 is a schematic diagram illustrating an example of a printing apparatus 100 adoptable to the present embodiment.

Coordinate axes illustrated in the drawings of the present disclosure are explained. An X direction corresponds to a width direction (overall length direction) of the printing apparatus 100. A Y direction corresponds to a depth direction of the printing apparatus 100. A Z direction corresponds to a height direction (gravitational direction) of the printing apparatus 100. In the present embodiment, a print medium 102 is conveyed in the X direction. Accordingly, the X direction also corresponds to the conveyance direction of the print medium 102. Moreover, the Y direction also corresponds to the width direction of the print medium 102.

In the present disclosure, “printing” means not only formation of meaningful information (for example, elicited characters, diagrams, or the like visually perceptible to humans) but also formation of meaningless information. Moreover, in the present disclosure, “printing” widely means formation of an image, a design, a pattern, a structure, a combination of these, or the like on a print medium and processing of the medium.

The “print medium” includes not only sheet used in a general printing apparatus but also media capable of receiving inks such as cloth, plastic film, metal plate, glass, ceramics, resin, wood, and leather.

As illustrated in FIG. 1, the printing apparatus 100 is configured to be capable of perform printing on the print medium 102 by ejecting liquids (for example, inks and the like). In the present embodiment, explanation is given assuming that the printing apparatus 100 is an inkjet printing apparatus and the print medium 102 is a cut sheet.

The printing apparatus 100 includes a feeding unit 104 configured to feed the print medium 102, a print head 101 configured to perform printing on the print medium 102, a conveying unit 103 configured to convey the print medium 102, and a discharging unit 105 configured to discharge the print medium 102.

In the case where the conveying unit 103 conveys the print medium 102 from the feeding unit 104 to a position directly below the print head 101, the liquids are ejected from many nozzles (not illustrated) formed in the print head 101, and an image is thereby printed on the print medium 102. In the case where the printing on the print medium 102 is completed, the conveying unit 103 discharges the print medium 102 to the discharging unit 105.

### <Print Head 101>

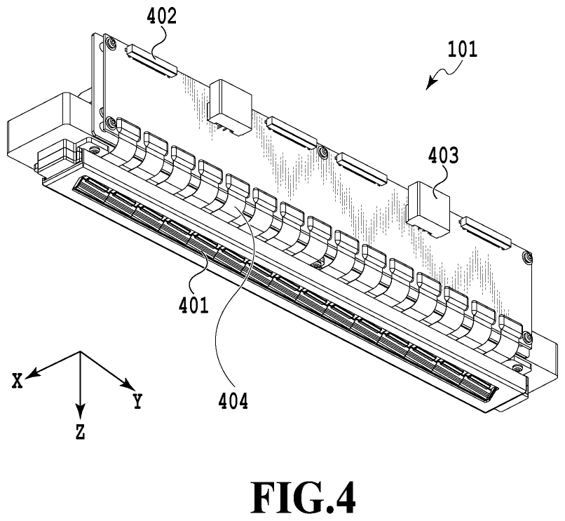

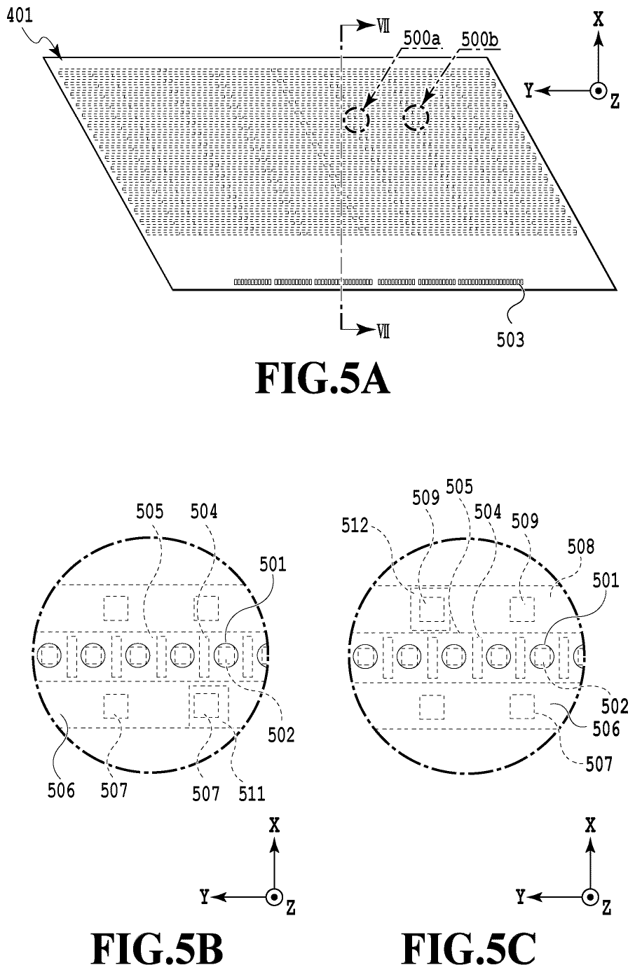

In the present embodiment, a full line head extending in the width direction (Y direction) of the print medium 102 is used as the print head 101. Multiple print element substrates 401 (see FIG. 4 and the like) are provided in a bottom portion of the print head 101. Multiple ejection ports 501 (see FIG. 5B and the like) are formed along a width direction (Y direction) of the print head 101 on an ejection port surface (surface facing downward in FIG. 1) of each of the print element substrates 401. These ejection ports 501 are formed to be capable of covering the width (length in the Y direction) of an image print region of a maximum size usable as the print medium 102.

In the present embodiment, five print heads 101 that eject a processing liquid, a cyan ink, a magenta ink, a yellow ink, and a black ink, respectively, are provided along the conveyance direction (X direction). Note that the types of the liquids, the colors of the liquids, the order in which the above-mentioned five print heads 101 are arranged, and the number of the print heads 101 are not limited to those in the above-mentioned example. The liquids ejected from the print heads 101 are stored in not-illustrated tanks. The liquids are supplied from the tanks to the print heads 101 via tubes.

### <Control System 200>

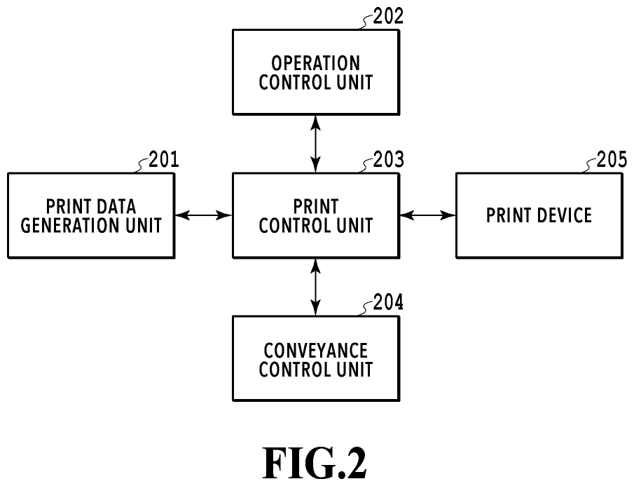

FIG. 2 is a block diagram illustrating an example of a control system 200 adoptable to the present embodiment.

As illustrated in FIG. 2, the control system 200 configured to control the printing apparatus 100 includes a print data generation unit 201, an operation control unit 202, a print control unit 203, a conveyance control unit 204, and a print device 205 as constitutional elements.

The print data generation unit 201 is a module configured to generate print data, and transmits the generated print data to the print control unit 203. Note that the print data generation unit 201 may be provided inside the printing apparatus 100, and may include a printer server or the like provided outside the printing apparatus 100.

The operation control unit 202 is a module that is operated by a user or a service staff and that receives instructions from the user or the service staff. Specifically, the operation control unit 202 includes an operation panel included in the printing apparatus 100, an operation PC connected to the printing apparatus 100, and the like. Note that, in the present embodiment, explanation is given assuming that the operation control unit 202 is the operation panel.

The print control unit 203 is a module that executes a print process. The conveyance control unit 204 is a module for conveying the print medium 102 (see FIG. 1 and the like). The print device 205 is a module used to control operations of the print head 101 (see FIG. 1 and the like).

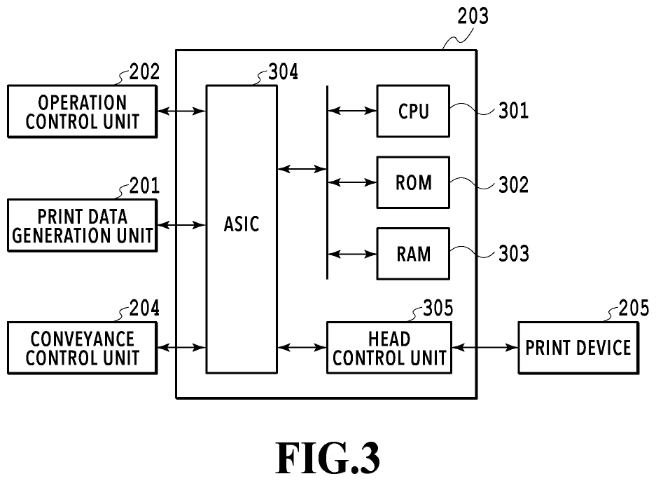

FIG. 3 is a block diagram illustrating an example of the print control unit 203 adoptable to the present embodiment.

As illustrated in FIG. 3, the print control unit 203 includes a CPU 301, a ROM 302, a RAM 303, an ASIC 304, and a head control unit 305.

The CPU 301 integrally controls operations of the printing apparatus 100 as a whole. The ROM 302 stores a control program and the like of the CPU 301. The RAM 303 temporarily stores data. The RAM 303 is used as a work memory in the case where programs are executed. The ASIC 304 is an application specific integrated circuit including a network controller, a serial IF controller, a head data generation controller, a motor controller, and the like.

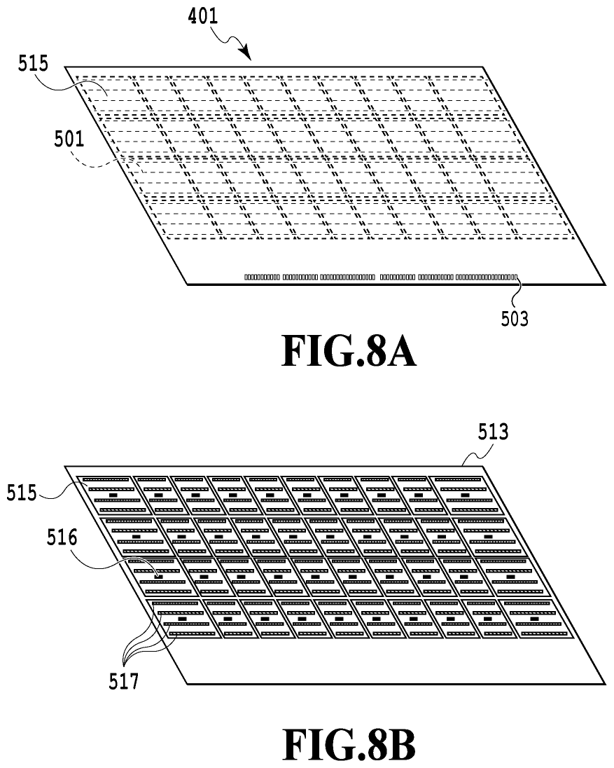

The head control unit 305 performs operations such as generation of ejection data used in the print device 205 and generation of voltages for driving ejection heaters 502 (see FIG. 5B) and heating elements (for example, sub-heaters 517 (see FIG. 8B)) for adjusting temperatures of the liquids.

### <Print Head 101>

FIG. 4 is a schematic perspective diagram illustrating an example of the print head 101 adoptable to the present embodiment.

In FIG. 4, one of the five print heads illustrated in FIG. 1 is illustrated. Note that configurations of these five print heads are the same except for the type of the ejected liquid.

As illustrated in FIG. 4, the print head 101 includes the print element substrates 401, signal input terminals 402, power supply terminals 403, and flexible wiring substrates 404.

In the present embodiment, multiple print element substrates 401 are linearly provided along a longitudinal direction (Y direction) of the print head 101. Drive signals for ejecting the liquid are transmitted from a main body of the printing apparatus 100 (see FIG. 1) to the print head 101 through the signal input terminals 402. Power necessary for ejecting the liquid is supplied from the main body of the printing apparatus 100 to the print head 101 through the power supply terminals 403. The signal input terminals 402 and the power supply terminals 403 are connected to the print element substrates 401 through the flexible wiring substrates 404.

### <Print Element Substrates 401>

FIG. 5A is a schematic bottom diagram of the adoptable print element substrate 401 in the present embodiment. Note that a bottom surface of the print element substrate 401 is referred to as “ejection port surface” as necessary.

As illustrated in FIG. 5A, terminals 503 for supplying power to electrothermal transducing elements (for example, ejection heaters 502 (see FIG. 5B and the like)) that are the printing elements for ejecting the liquid are provided on the ejection port surface of the print element substrate 401. The flexible wiring substrates 404 (see FIG. 4) are connected to the terminals 503. Pulse signals are supplied from the outside of the print head 101 (see FIG. 1 and the like) via the flexible wiring substrates 404 and the terminals 503. Electric currents for driving the ejection heaters 502 are generated depending on these pulse signals.

FIG. 5B is an enlarged diagram of a region 500a in FIG. 5A.

As illustrated in FIG. 5B, multiple ejection ports 501 for ejecting the liquid are formed along the Y direction on the ejection port surface of the print element substrate 401. The direction in which the multiple ejection ports 501 are formed is referred to as “ejection port array direction”.

The ejection heaters 502 that are the print elements configured to eject the liquid to the print medium 102 (see FIG. 1) are provided at positions corresponding to the respective ejection ports 501. The print elements are formed along the Y direction, and one print element array is thereby formed. The print element arrays are provided along the X direction, and multiple print element arrays are thereby formed.

In the present embodiment, electrothermal transducing elements (specifically, ejection heaters 502) configured to cause bubbling of the liquid by using thermal energy are used as the print elements. Note that electromechanical transducing elements (for example, piezoelectric elements) may be used instead of the electrothermal transducing elements. The liquid can be ejected also in this case. The ejection heaters 502 are electrically connected to the terminals 503 by electric wiring (not illustrated) formed inside the print element substrate 401.

Moreover, the ejection heaters 502 generate heat based on the pulse signals received from the head control unit 305 (see FIG. 3) via the signal input terminals 402 and the power supply terminals 403 (see FIG. 4) to cause film boiling in the liquid.

The liquid is ejected from the ejection ports 501 by using force of bubbling caused by the film boiling. Moreover, partitions 504 define pressure chambers 505 at positions corresponding to the respective ejection ports 501. Liquid supply passages 506 configured to supply the liquid to the pressure chambers 505 are formed along the ejection port array direction. Supply ports 507 for supplying the liquid to the pressure chambers 505 are formed in the liquid supply passages 506. The liquid supplied to the liquid supply passages 506 is supplied to the pressure chambers 505 via the supply ports 507. In the case where the liquid is supplied to the pressure chambers 505 and the ejection heaters 502 are driven, the liquid is ejected from the ejection ports 501.

FIG. 5C is an enlarged diagram of a region 500b of FIG. 5A.

As illustrated in FIG. 5C, liquid collection passages 508 for collecting the liquid is formed along the ejection port array direction on the opposite side of the ejection port arrays to the liquid supply passages 506. The liquid that is supplied to the pressure chambers 505 and that is not ejected passes through collection ports 509, and is collected into the liquid collection passages 508.

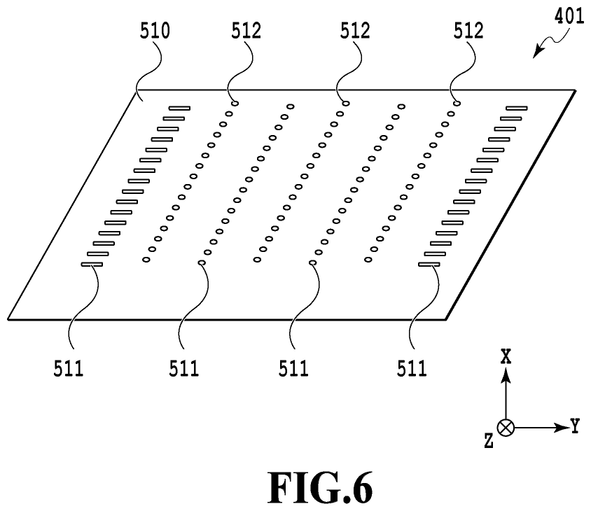

FIG. 6 is a schematic plan diagram of the print element substrate 401 in the present embodiment. Specifically, a back side of the ejection port surface of the print element substrate 401 is illustrated in FIG. 6.

As illustrated in FIG. 6, a cover plate 510 is provided on the back side of the print element substrate 401. The cover plate 510 is stacked on a back surface of the surface of the print element substrate 401 on which the ejection ports 501 are formed. Supply openings 511 connected to the liquid supply passages 506 (see FIG. 5B and the like) and collection openings 512 connected to the liquid collection passages 508 (see FIG. 5B and the like) are formed in the cover plate 510.

In the present embodiment, four supply openings 511 are formed for one liquid supply passage 506, and three collection openings 512 are formed for one liquid collection passage 508. However, the number of openings that can be formed in the cover plate 510 is not limited to this example.

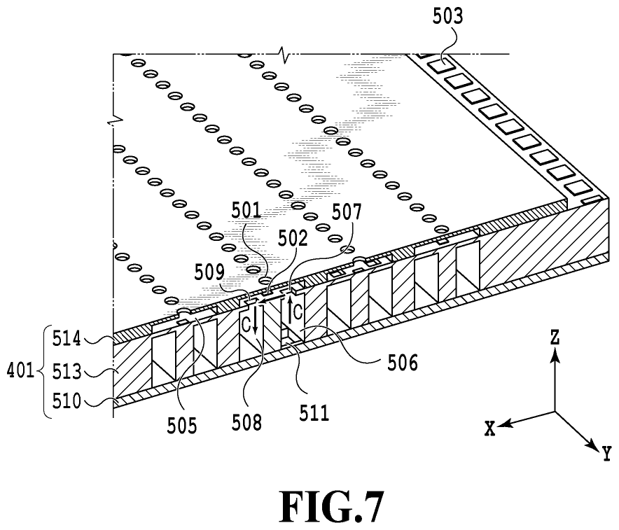

FIG. 7 is a cross-sectional diagram of a VII-VII line in FIG. 5A.

As illustrated in FIG. 7, the print element substrates 401 is formed by stacking the cover plate 510, a substrate 513, and an ejection port forming member 514 one on top of another in this order. Stacking the cover plate 510, the substrate 513, and the ejection port forming member 514 one on top of another in this order causes the cover plate 510 to function as a lid that forms part of walls of the liquid supply passages 506 and the liquid collection passages 508 formed in the substrate 513.

The substrate 513 is made of Si or the like. The ejection port forming member 514 is made of a photosensitive resin. The cover plate 510 is fixed to the back surface of the substrate 513. The ejection heaters 502 are provided on the surface of the substrate 513 on the side bonded to the ejection port forming member 514. On the back surface side of this surface, grooves forming the liquid supply passages 506 and the liquid collection passages 508 extending along the ejection port arrays are formed.

As described above, the liquid supply passages 506 and the liquid collection passages 508 are formed by fixing the cover plate 510 to the substrate 513. The liquid supply passages 506 are connected to a common supply flow passage (not illustrated) through the supply openings 511. Meanwhile, the liquid collection passages 508 are connected to a common collection flow passage (not illustrated) through the collection openings 512.

A flow of the liquid inside the print element substrate 401 is explained below. A pressure difference is generated between the liquid supply passages 506 and the liquid collection passages 508. This pressure difference causes the liquid inside the liquid supply passages 506 to flow to the liquid collection passages 508 while passing through the supply ports 507, the pressure chambers 505, and the collection ports 509 in this order (see the arrows C).

This flow allows bubbles, foreign objects, a thickened ink generated by evaporation from the ejection ports 501, and the like in the ejection ports 501 and the pressure chambers 505 not performing an ejection operation to be collected into the liquid collection passages 508. Moreover, thickening of the ink in the ejection ports 501 and the pressure chambers 505 and an increase in a concentration of a color material can be suppressed.

That is the explanation of the flow of the liquid inside the print element substrate 401.

FIG. 8A is a diagram explaining temperature control of the ejection port surface of the print element substrate 401.

FIG. 8B is a schematic bottom diagram of the substrate 513.

As illustrated in FIGS. 8A and 8B, in the present embodiment, the substrate 513 of the print element substrate 401 is divided into multiple regions, and the temperature control is performed for each of these regions. In FIGS. 8A and 8B, explanation is given while each of the multiple divided regions is referred to as a divided region 515 for the convenience of explanation. Note that, although broken lines defining each of the divided regions 515 are illustrated in FIG. 8A, these broken lines are imaginary lines. The same applies to the drawings other than FIG. 8A.

An element substrate (substrate 513) includes temperature sensors 516 configured to detect temperatures and the sub-heaters 517 configured to heat the liquid. At least one of the temperature sensors 516 and at least one of the sub-heaters 517 are provided in each of the multiple divided regions 515 obtained in the case where the substrate 513 is divided into multiple regions. The temperature sensors 516 functions as temperature obtaining units configured to obtain the temperatures of the divided regions 515. The sub-heaters 517 function as temperature adjusting units configured to adjust the temperatures of the divided regions 515.

According to this configuration, it is possible to individually obtain the temperature of each of the divided regions 515 and perform appropriate heating depending on the obtained temperature. Specifically, in the case where a temperature distribution is occurring in the substrate 513, it possible to perform different heating control for each of positions where the temperature distribution is occurring. Note that the arrangement positions, the arrangement numbers, and the shapes of the temperature sensors 516 and the sub-heaters 517 are not limited to those in the example illustrated in FIG. 8B.

### <Control Process of Sub-Heaters 517>

In the case where the temperature differs among the multiple divided regions 515, a difference in viscosity of the liquid occurs, and a difference in the amount of the liquid ejected from each ejection port 501 occurs. Accordingly, the temperature sensors 516 and the sub-heaters 517 are provided near the ejection ports 501. Drive of the sub-heaters 517 is controlled depending on the temperatures detected by the temperature sensors 516, and the temperature adjustment is performed such that the temperatures of all divided regions become the same. A temperature set in the case where this control is performed is referred to as “target temperature”.

A tendency of being heated differs depending on the position on the print element substrate 401 in some cases. Accordingly, different target temperatures may be set for the respective divided regions 515 depending on the tendency of being heated. Meanwhile, a value of the target temperature common to all divided regions 515 may be set. In the case where the temperature detected by one of the temperature sensors 516 is lower than the target temperature, the sub-heaters 517 of the divided region 515 corresponding to this temperature sensor 516 are turned on. This can increase the temperature of this divided region 515.

Meanwhile, in the case where the temperature detected by the temperature sensor 516 is higher than the target temperature, the sub-heaters 517 of the divided region 515 corresponding to this temperature sensor 516 are turned off. This can cause the temperature to fall by heat dissipation in this divided region 515.

A difference between a tendency of a center portion of the print element substrate 401 being heated and a tendency of an end portion of the print element substrate 401 being heated is explained below.

Generally, at a normal temperature, the temperature of the print element substrate 401 is lower than the target temperature suitable for ejection. Accordingly, at a timing of start of the temperature control such as a timing at which the power of the apparatus is turned on, it is necessary to turn all sub-heaters 517 on and increase the temperature of the print element substrate 401 until it reaches the target temperature.

In the center portion of the print element substrate 401, the sub-heaters 517 provided in the divided region 515 of interest (interest region) are turned on, and the sub-heaters 517 provided in the divided regions 515 (adjacent regions) adjacent to the interest region are also turned on. Specifically, in the center portion of the print element substrate 401, the interest region receives heat also from the adjacent regions around the interest region. Accordingly, it can be said that, in the center portion of the print element substrate 401, the region has a relatively high tendency of being heated.

Meanwhile, the number of adjacent regions adjacent to the interest region in the end portion of the print element substrate 401 is smaller than that in the center portion of the print element substrate 401. Specifically, it can be said that, in the end portion of the print element substrate 401, the number of adjacent regions around the interest region that can give heat to the interest region is small, and the interest region has a relatively low tendency of being heated. Accordingly, a degree of dependence on the sub-heaters 517 provided in the interest region in the end portion of the print element substrate 401 is higher than that in the center portion of the print element substrate 401. Accordingly, in the end portion of the print element substrate 401, it is preferable to set a drive intensity of the sub-heaters 517 higher than that in the center portion of the print element substrate 401 and increase the temperature.

That is the explanation of the difference between the tendency of the center portion of the print element substrate 401 being heated and the tendency of the end portion of the print element substrate 401 being heated.

Moreover, the temperature of the print element substrate 401 is desirably maintained at the target temperature after reaching the target temperature. Note that, even if the temperature of the print element substrate 401 deviates from the target temperature after reaching the target temperature, it is desirable to minimize an amount of this deviation. To this end, the drive intensity of the sub-heaters 517 needs to be set lower than that immediately after start of the temperature adjustment.

Moreover, after the temperature reaches the target temperature, a difference between the drive intensity of the sub-heaters 517 in the center portion of the print element substrate 401 and the drive intensity of the sub-heaters 517 in the end portion of the print element substrate 401 does not have to be as large as that immediately after start of the temperature adjustment.

### <Processes for Maintaining Target Temperature>

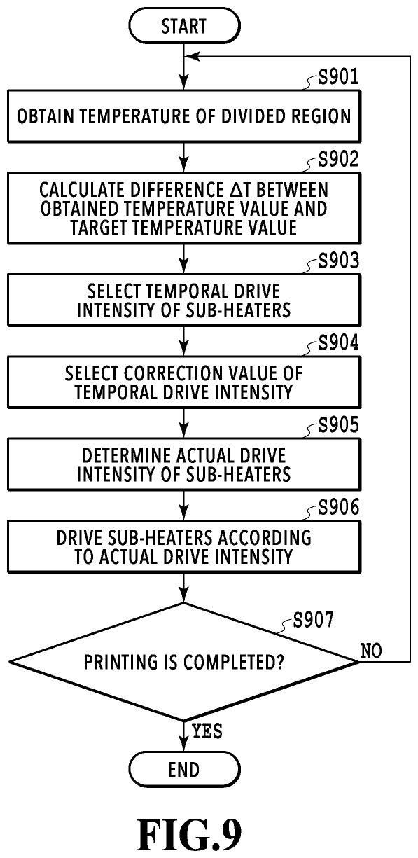

Processes for maintaining the target temperature are explained below by using FIG. 9.

FIG. 9 is a flowchart illustrating processes for maintaining the target temperature by driving the sub-heaters 517 of the present embodiment. The CPU 301 performs each of the processes in the flow illustrated in FIG. 9 by loading a program code stored in the ROM 302 or the like onto the RAM 303 and executing the program code.

Some or all of functions of the steps in FIG. 9 may be executed by hardware such as an ASIC, a FPGA, or an electric circuit. Note that “step S” is simply described as “S” below.

Explanation is given below assuming that a subject that performs the processes is the print control unit 203.

The flow of FIG. 9 is an interrupt processing performed at a certain interval during printing, and is triggered by presence of this interruption. Moreover, it is assumed that the target temperature is set before start of the flow illustrated in FIG. 9, and is stored in a storage unit such as the ROM 302.

In S901, the print control unit 203 obtains a temperature value detected by the temperature sensor 516 for each divided region 515.

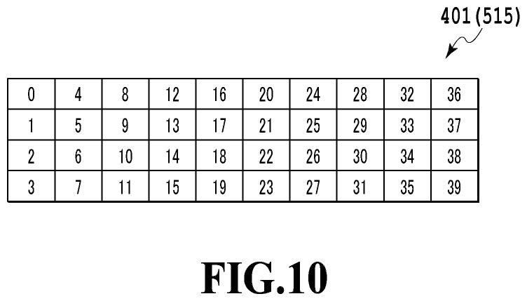

FIG. 10 is a diagram illustrating the position and the region number of each of the multiple divided regions 515 in the print element substrate 401.

As illustrated in FIGS. 10, 40 divided regions 515 are provided in the print element substrate 401 of the present embodiment, and the region numbers of 0 to 39 are individually assigned to the respective divided regions 515. Note that, as illustrated in FIGS. 8A and 8B, the shapes of the print element substrate 401 and the divided regions 515 are parallelograms in the present embodiment. However, in FIG. 10, the shapes of the print element substrate 401 and the divided regions 515 are illustrated in rectangles for the convenience of explanation.

The technique of the present disclosure can be applied irrespective of the shapes of the print element substrate 401 and the divided regions 515, as long as the print element substrate 401 is divided into multiple divided regions 515 and the temperature adjustment can be performed for each of the divided regions 515. Explanation returns to FIG. 9.

In S902, a difference ΔT (=target temperature value-detected temperature) obtained by subtracting the temperature value obtained in S901 from the target temperature value stored in advance is calculated for each divided region 515. The case where ΔT is a positive value means that the detected temperature is lower than the target temperature. The case where ΔT is a negative value means that the detected temperature is higher than the target temperature.

In S903, the print control unit 203 selectively determines a first drive intensity (temporal drive intensity) for the sub-heaters 517 for each divided region 515 based on the difference ΔT calculated in S902.

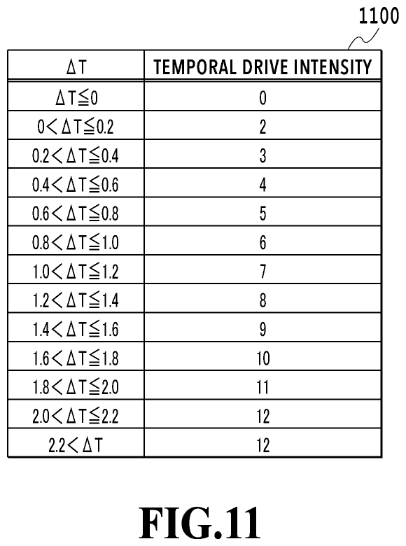

FIG. 11 is a diagram illustrating an example of a first table 1100 used in S903.

As illustrated in FIG. 11, in the first table 1100, a value representing the temporal drive intensity is defined for each of ranges of the value of the difference ΔT. The first table 1100 is stored in the storage unit such as the ROM 302. In the present embodiment, the temporal drive intensity is represented in an integer for the sake of convenience, and the larger the value is, the higher the drive intensity is.

In the case where the difference ΔT is equal to or smaller than “0”, the value representing the temporal drive intensity is determined to be “0”. Meanwhile, in the case where the difference ΔT is larger than “0”, the temporal drive intensity is determined to be a value larger than “0”.

The larger the difference ΔT is, the larger the selected value of the temporal drive intensity is. Note that a lower limit value and an upper limit value are provided for the temporal drive intensity. For example, in the case where the difference ΔT is “0” or smaller, the temporal drive intensity is determined to be “0”. Meanwhile, in the case where the difference ΔT exceeds “2.2”, the temporal drive intensity is determined to be “12”. Explanation returns to FIG. 9.

In S904, the print control unit 203 determines a correction value for correcting the temporal drive intensity determined in S903, for each divided region 515. This correction value is determined based on the difference ΔT and the value (region number) representing the position of the divided region 515.

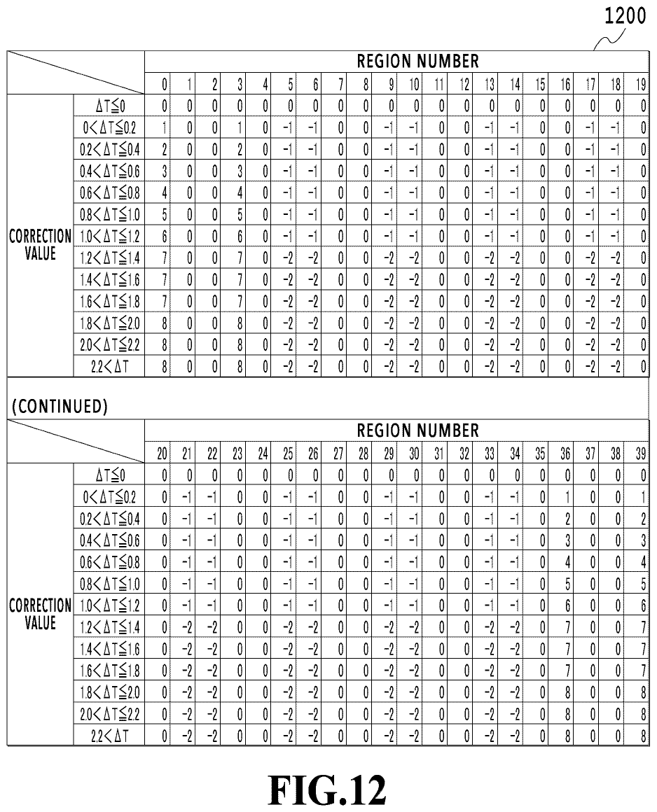

FIG. 12 is a diagram illustrating an example of a second table 1200 used in S904. The second table 1200 is stored in the storage unit such as the ROM 302.

As illustrated in FIG. 12, in the second table 1200, the correction value for correcting the first drive intensity (temporal drive intensity) depending on the magnitude of the difference ΔT is defined for each of the values (region numbers) representing the positions of the divided regions. Note that a lower limit value (−2) and an upper limit value (+8) are provided for the correction value.

In the present embodiment, types of values selectable as the correction value for correcting the temporal drive intensity are fewer than types of values selectable as the first drive intensity (temporal drive intensity).

For example, in the present embodiment, the number of types of values selectable as the correction value for correcting the temporal drive intensity is 11 types from “−2” to “+8” including “0”. Meanwhile, the number of types of values selectable as the first drive intensity (temporal drive intensity) is 13 types from “0” to “12” (see FIG. 11). Making the types of values selectable as the correction value fewer than the types of values selectable as the temporal drive intensity as described above can contribute to reduction of a data volume to be described later.

In the second table 1200, in the case where the difference ΔT is “0” or smaller, the correction value is determined to be 0 irrespective of the region number (specifically, the position of the divided region 515 (see FIG. 8B and the like) to be the target of the temperature control)). This is because, in this case, the temperature of the divided regions 515 being the target of the temperature control has reached or exceeded the target temperature, and a value (0) indicating the drive intensity of the sub-heaters 517 (see FIG. 8B) temporarily determined as the temporal drive intensity should be adopted as an actual drive intensity. In other words, this is because the sub-heaters 517 do not have to be driven or the sub-heaters 517 need to be turned off until the detected temperature falls to the target temperature by heat dissipation for such a divided region 515.

Meanwhile, in the case where the difference ΔT is larger than 0, the value of the correction value differs depending on the positions of the divided regions 515. For example, the correction value of the sub-heaters 517 provided in the divided region 515 located at a corner of the print element substrates 401 (see FIG. 11 and the like) is determined to be a positive value larger than “0”. Specifically, for such a divided region 515, correction in a direction in which the temporal drive intensity is further increased is performed. Moreover, the larger the difference ΔT is, the larger the absolute value of the correction value is.

As illustrated in FIG. 11, the regions “0”, “3”, “36”, and “39” are located at corners of the print element substrate 401, and have a characteristic of a low tendency of being heated. Accordingly, in these regions, even after the temperature reaches the target temperature once, the correction value for correcting the temporal drive intensity in the case where the temperature falls from the target temperature is determined to be a positive value larger than “0” to further increase the temporal correction intensity.

Moreover, for example, the correction value of the sub-heaters 517 provided in the divided region 515 located in the center portion (for example, region “5” illustrated in FIG. 11) of the print element substrate 401 is determined to be a negative value smaller than “0”. Specifically, for such a divided region 515, correction in a direction in which the temporal drive intensity is reduced is performed. Moreover, the larger the difference ΔT is, the larger the absolute value of the correction value is.

The divided region 515 located in the center portion of the print element substrate 401 has many adjacent divided regions 515, and has a characteristic of a high tendency of being heated. Accordingly, in such regions, after the temperature reaches the target temperature once, even in the case where the temperature falls, not much heating is needed to cause the temperature to return to the target temperature again. Thus, the correction value for correcting the temporal drive intensity is determined to be a negative value to reduce the temporal drive intensity.

Moreover, the correction value of the sub-heaters 517 provided in the divided regions 515 located in an edge portions (end portions) of the print element substrate 401 other than the corners is determined to be “0” irrespective of the magnitude of the difference ΔT.

In the edge portions (for example, region “1” and the like illustrated in FIG. 11) of the print element substrate 401 other than the corner portions, there are more adjacent divided regions 515 than in the corners of the print element substrate 401. Meanwhile, there are fewer adjacent divided regions 515 than in the center portion of the print element substrate 401. Accordingly, the edge portions of the print element substrate 401 other than the corners have a characteristic of a higher tendency of being heated than the corners of the print element substrate 401 but a lower tendency of being heated than the center portion of the print element substrate 401. Accordingly, in the present embodiment, in the edge portions of the print element substrate 401 other than the corners, correction of the temporal drive intensity is assumed to be unnecessary, and “0” is defined as the correction value irrespective of the magnitude of the difference ΔT.

According to this configuration, even in the case where the tendency of being heated differs depending on the position in the print element substrate 401, it is possible to correct the drive intensity of the sub-heaters 517 provided at each position while additionally taking the tendency of being heated unique to the position into consideration.

A relationship of the drive intensity depending on the divided region 515 of the print element substrate 401 described above is summarized. In the case where the difference ΔT is “0” or less, in the corners that have a high tendency of being heated, the correction value is determined in the direction in which the temporal drive intensity is increased, and in the center portion that has a low tendency of being heated, the correction value is determined in the direction in which the temporal drive intensity is reduced. Moreover, in the present embodiment, in the edge portions (end portions) that have a higher tendency of being heated than the corners and a lower tendency of being heated than the center portion, “0” is determined as the correction value. This is merely an example, and it is only necessary that a value between the correction value in the corners and the correction value in the center portion is set from the viewpoint of tendency of being heated. Moreover, as illustrated in FIG. 12, at the same difference ΔT, the correction value set for the divided region 515 with few adjacent regions is equal to or larger than the correction value set for the divided region 515 with many adjacent regions. Furthermore, the absolute value of the correction value in the case where the difference ΔT is larger than “0” is equal to or larger than the absolute value of the correction value in the case where the difference ΔT is “0” or smaller, irrespective of location.

Note that, although the correction value and the temporal drive intensity are determined based on whether the difference ΔT is larger or smaller than “0” in the present embodiment, the value for this determination is not limited to “0”, and may be set to a predetermined value. Specifically, in the case where the difference ΔT is a first value smaller the predetermined value, the correction value is set to “0” that is a value at which the temporal drive intensity is not corrected. Moreover, in the case where the difference ΔT is a value (second value larger than the first value) larger than the predetermined value, the correction value is determined depending on each location.

Returning to FIG. 9, in S905, the print control unit 203 adds the correction value selected in S904 to the value representing the temporal drive intensity selected in S903, and determines the actual drive intensity (second drive intensity) of the sub-heaters 517 for each of the multiple divided regions 515.

In S906, the print control unit 203 drives the sub-heaters 517 according to the second drive intensity determined in S905.

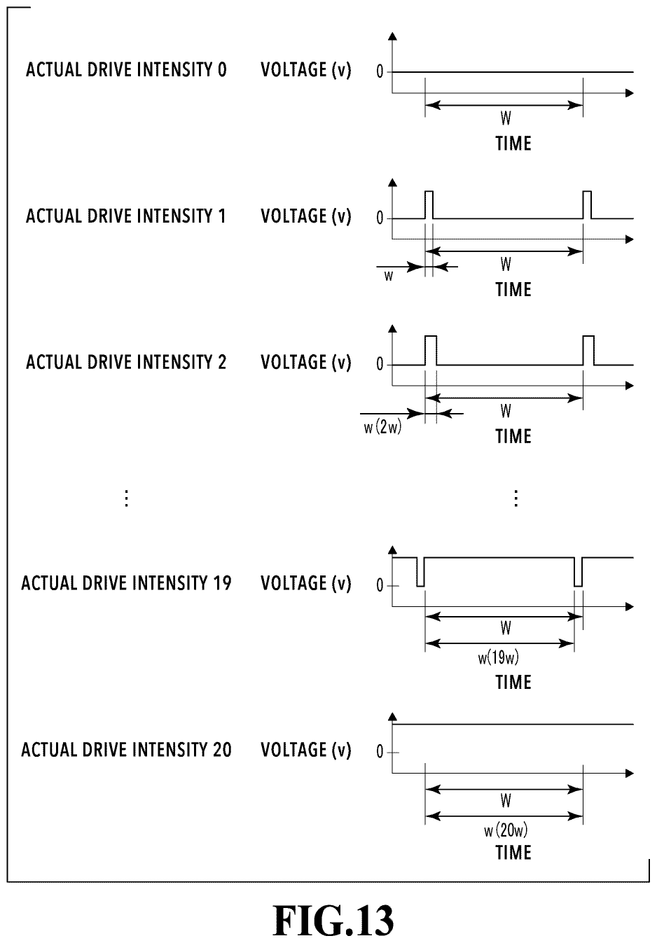

FIG. 13 is a graph illustrating a relationship between time and voltage in the case where the sub-heaters 517 are driven according to the second drive intensity. This graph illustrates a timing chart with a cycle W for each of drive intensities to compare the timing charts with one another. In the case where the sub-heaters are actually driven in S906, a voltage according to one of the timing charts with the cycle W as described above is repeatedly applied for a predetermined period.

As illustrated in FIG. 13, the print control unit 203 applies the voltage at a pulse width corresponding to the second drive intensity, and drives the sub-heaters 517.

In the present embodiment, the larger the value of the second drive intensity of the sub-heaters 517 is, the longer the time period of continuously applying the voltage to the sub-heaters 517 is. Specifically, in the case where the second drive intensity is “0”, no voltage is applied to the sub-heaters 517. Moreover, in the case where the second drive intensity is “1”, a voltage V is applied to the sub-heaters 517 for a period w every cycle W.

Furthermore, in the case where the second drive intensity is “2”, the voltage V is applied to the sub-heaters 517 for a period 2 w every cycle W. Moreover, in the case where the second drive intensity is “19”, the voltage V is applied to the sub-heaters 517 for a period 19 w every cycle W. Since W=20 w in the present embodiment, in the case where the second drive intensity is “20”, the voltage V is continuously applied to the sub-heaters 517.

As a result, increasing the value indicating the second drive intensity can increase the amount of heat applied to the divided region 515 to be heated, and the temperature of this divided region 515 can be increased.

Note that, although the configuration may be such that increasing the value indicating the second drive intensity changes, specifically, increases the pulse width in the drive of the sub-heaters 517 as illustrated in FIG. 13, the present disclosure is not limited to this configuration. For example, the configuration may be such that increasing the value indicating the second drive intensity increases the value of the voltage applied to the sub-heaters 517 or increases the frequency. Explanation returns to FIG. 9.

In S907, the print control unit 203 determines whether printing is completed or not. If the printing is not completed, the print control unit 203 executes the process of S901. Meanwhile, if the printing is completed, the print control unit 203 terminates the series of process in FIG. 9.

That is the explanation of the processes for maintaining the target temperature in printing.

### Specific Examples

A specific example of the temperature adjustment adoptable to the technique of the present disclosure is explained below.

In this section, description is given of an example in which the correction value for the temporal drive intensity of the sub-heaters 517 provided in a target region that is the target of the temperature adjustment is selected depending on differences in the number of adjacent divided regions 515 adjacent to the target region. It is assumed that, as illustrated in FIG. 10, the temperature control is performed with the print element substrate 401 divided into 40 divided regions 515.

In this section, each of the divided regions 515 to which the region numbers from 0 to 39 illustrated in FIG. 10 are assigned is simply referred to as “region” depending on the number assigned to the divided region 515 for the convenience of explanation. For example, the divided region 515 to which the region number 0 is assigned is simply referred to as “region 0”. Moreover, explanation is given assuming that the current detected temperature of each divided region 515 is 35° C., and the target temperature is 40° C. Specifically, explanation is given assuming that the temperature of each divided region 515 is to be increased by 5° C. and maintained around 40° C.

First, an example of the temperature adjustment for “region 0” is explained. In this case, the print control unit 203 obtains information indicating that the temperature of “region 0” is 35° C. (S901). Then, the print control unit 203 calculates the difference ΔT (=target temperature value-detected temperature=5° C.) between the value of the target temperature (40° C.) and the value of the temperature obtained in S901 (35° C.) (S902).

Then, the print control unit 203 refers to the first table 1100, and selects the temporal drive intensity of the sub-heaters 517 provided in the region 0 (S903). Since the difference ΔT is 5° C. and exceeds 2.2° C. in the present example, “12” is selected as the value representing the temporal drive intensity (see FIG. 11).

Then, the print control unit 203 refers to the second table 1200, and selects the correction value for the selected temporal drive intensity (S904). Since the difference ΔT of the region 0 is 5° C. in the present example, “8” is selected as the correction value for the temporal drive intensity (see an intersection of correction value “2.2<ΔT” and “region number 0” in FIG. 12).

Then, the print control unit 203 adds the correction value (8) selected in S904 to the temporal drive intensity (12) selected in S903 to determine the actual drive intensity of the sub-heaters 517 provided in the region 0 (S905). In the present example, the actual drive intensity of the sub-heaters 517 is determined to be “20”.

Then, the print control unit 203 drives the sub-heaters 517 provided in the region 0 at the determined drive intensity (20).

Then, if the printing is terminated (YES in S907), the temperature adjustment for the region 0 is terminated.

Next, an example of the temperature adjustment for “region 5” is explained. In this case, the print control unit 203 obtains information indicating that the temperature of “region 5” is 35° C. (S901). Subsequently, the print control unit 203 calculates the difference ΔT (=target temperature-detected temperature=5° C.) between the value of the target temperature (40° C.) and the value of the temperature (35° C.) obtained in S901 (S902).

Then, the print control unit 203 refers to the first table 1100, and selects the temporal drive intensity of the sub-heaters 517 provided in the region 5 (S903). In the present example, the difference ΔT is 5° C. and exceeds 2.2° C. Accordingly, “12” is selected as the value representing the temporal drive intensity (see FIG. 11).

Then, the print control unit 203 refers to the second table 1200, and selects the correction value for the selected temporal drive intensity (S904). In the present example, since the difference ΔT of the region 5 is 5° C., “−2” is selected as the correction value for the temporal drive intensity (see an intersection of correction value “2.2<ΔT” and “region number 5” in FIG. 12).

Then, the print control unit 203 adds the correction value (−2) selected in S904 to the value (12) representing the temporal drive intensity selected in S903 to determine the actual drive intensity of the sub-heaters 517 provided in the region 0 (S905). In the present example, the actual drive intensity of the sub-heaters 517 is determined to be “10”.

Then, the print control unit 203 drives the sub-heaters 517 provided in the region 5 at the determined drive intensity (10).

Then, if the printing is terminated (YES in S907), the temperature adjustment for the region 5 is terminated.

As explained above, in the technique of the present disclosure, in the region with few adjacent regions, the heat amount received from the regions adjacent to this region is small. Accordingly, in this region, correction is performed such that the drive intensity in the drive of the sub-heaters 517 is increased.

For example, with reference to FIG. 10, the drive intensity in the drive of the sub-heaters 517 provided in the region 0 adjacent only to the regions 1 and 4 is determined to be “20” that is the highest drive intensity. Meanwhile, in the region with many adjacent regions, the heat amount received from the regions adjacent to this region is large. Accordingly, in this region, correction is performed such that the drive intensity in the drive of the sub-heaters 517 is reduced.

For example, the drive intensity in the drive of the sub-heaters 517 provided in the region 5 adjacent to the regions 1, 4, 6, and 9 is determined to be “10” that is half the drive intensity of the sub-heaters 517 provided in the region 0.

In order to facilitate understanding of effects of the technique of the present disclosure, explanation is given below by describing a conventional technique and a hypothetical comparison example.

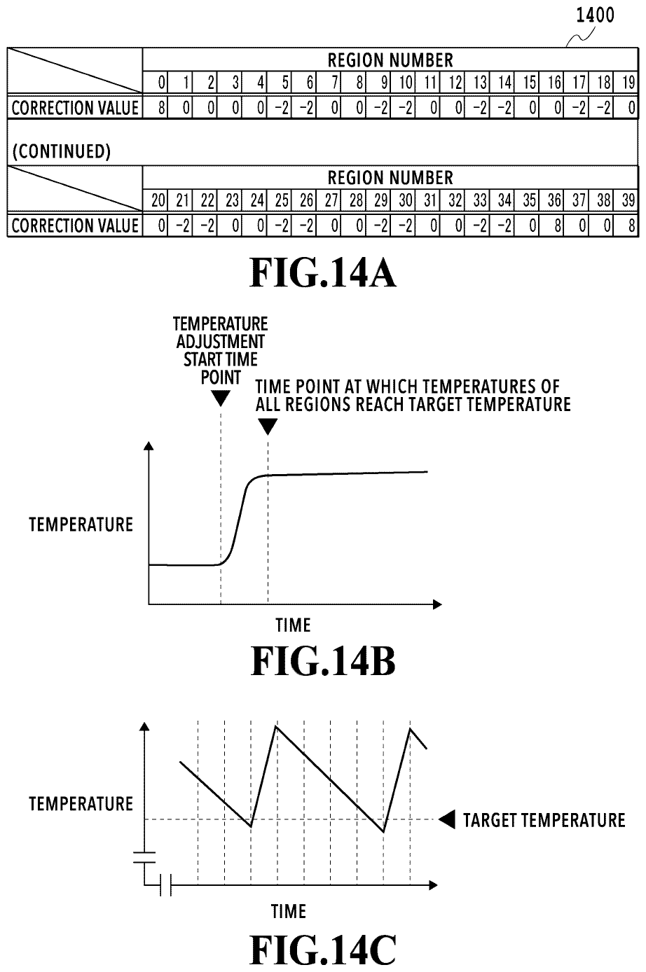

FIG. 14A is a diagram illustrating an example of a table 1400 of the conventional technique. In the conventional technique, the correction value is determined based on only the position of the divided region, irrespective of the difference ΔT between the detected temperature and the target temperature. The table 1400 of FIG. 14A focuses on reduction of a time period from start of the temperature adjustment to reaching of the target temperature, and is identical to the contents of the row of “2.2<ΔT” in the second table 1200 illustrated in FIG. 12. FIG. 14B is a graph illustrating a temperature change from start of the temperature adjustment to reaching of the target temperature in the region 0 of the present example. FIG. 14C is a graph illustrating a temperature change after reaching of the target temperature in the region 0 of the present example.

As illustrated in FIGS. 14A to 14C, in the region 0 of the present example, the correction value of “+8” is selected irrespective of the detected temperature of the region 0. According to the conventional technique, a large value (specifically, “+8”) is set as the correction value of the drive intensity of the sub-heaters provided in the region 0 located at the corner (position with a low tendency of being heated) of the print element substrate, irrespective of the detected temperature of the region 0. Accordingly, the drive intensity of the sub-heaters provided at the corner of the print element substrate is always set on the high side.

For example, in the case where the difference ΔT between the detected temperature of the region 0 and the target temperature is 5° C., “12” is selected as the temporal drive intensity of the sub-heaters. Then, as a result of adding the correction value (+8) to the temporal drive intensity (12), the actual drive intensity of the sub-heaters is determined to be “20”. Accordingly, in the present example, the actual drive intensity of the sub-heaters provided at the position with a low tendency of being heated can be set high. Thus, as illustrated in FIG. 14B, the temperature of the region 0 located at the position with a low tendency of being heated can be made to reach the target temperature from the normal temperature in a relatively-short time period.

However, in the region 0 of the conventional technique, the drive intensity is set high also in the temperature control after reaching of the target temperature. Accordingly, the temperature control performed at a timing where the temperature falls slightly below the target temperature sometimes causes the temperature to greatly exceed the target temperature. Then, continuing such temperature control causes a state where the temperature is higher than the target temperature to be maintained as illustrated in FIG. 14C.

In principle, the temperature ideally changes with the target temperature being a median value. To this end, after the temperature of the region 0 reaches the target temperature once, the sub-heaters provided in the region 0 should not be driven so intensely at the timing where the temperature falls below the target temperature. Regardless of this, in the conventional technique, a large value is set as the correction value for driving the sub-heaters provided in the region 0 also after the temperature of the region 0 reaches the target temperature. As a result, in the region 0, the drive intensity of the sub-heaters is too high after reaching of the target temperature.

After the temperature of the region 0 exceeds the target temperature, the sub-heaters are turned off, and the temperature of the region 0 falls. However, under the conventional technique, repeating on and off the sub-heaters causes the temperature to wildly fall and rise repeatedly in the region 0 as illustrated in FIG. 14C. Specifically, in the conventional technique, although the time period from start of the temperature adjustment to reaching of the target temperature can be reduced, it is difficult to appropriately maintain the target temperature.

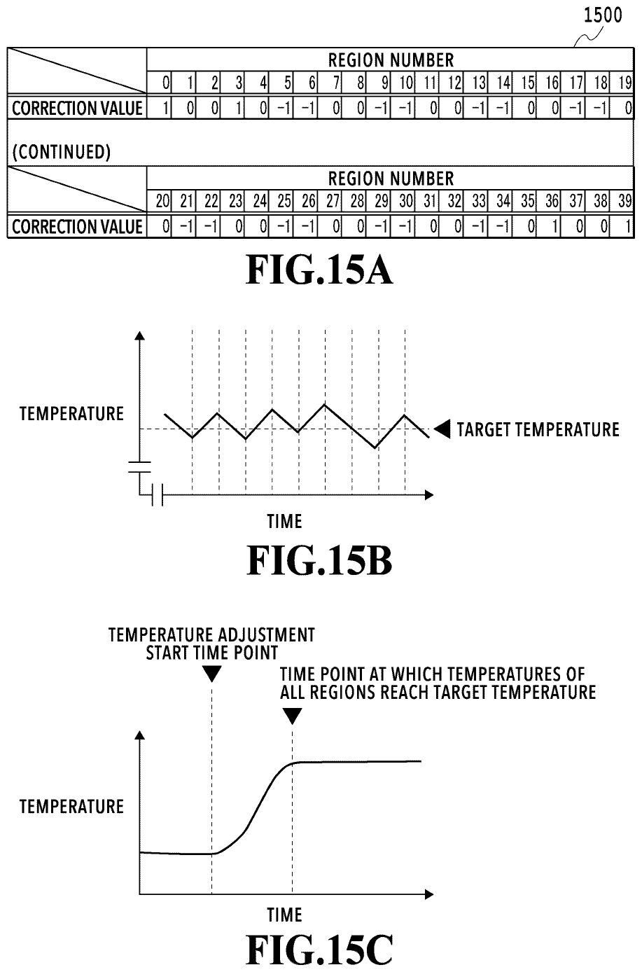

FIG. 15A is a diagram illustrating another example of the table of the conventional technique. The table 1500 of FIG. 15A focuses on maintaining of the target temperature after the temperature reaches the target temperature once, and is identical to the contents of the row of “0<ΔT<0.2” in the second table 1200 illustrated in FIG. 12. FIG. 15B is a graph illustrating a temperature change after reaching of the target temperature in the region 0 of the present example. FIG. 15C is a graph illustrating a temperature change after the temperature reaches the target temperature from the normal temperature in the region 0 of the present example.

As illustrated in FIGS. 15A to 15C, in the region 0 of the present example, the correction value of “+1” is selected irrespective of the detected temperature of the region 0. According to this configuration, a small value (specifically, “+1”) is set as the correction value of the drive intensity of the sub-heaters provided in the region 0, irrespective of the detected temperature.

For example, in the case where the difference ΔT between the detected temperature of the region 0 and the target temperature is 0.2° C., “2” is selected as the temporal drive intensity of the sub-heaters. Then, as a result of adding the correction value “1” to the temporal drive intensity “2”, the actual drive intensity of the sub-heaters is determined to be “3”. As a result, according to the present example, as illustrated in FIG. 15B, the temperature of the region 0 can be maintained at a value closer to the target temperature than that in FIG. 14C after the temperature of the region 0 reaches the target temperature.

However, in this configuration, the correction value of the drive intensity is always set to a small value (specifically, “3”) also for the sub-heaters provided in the region 0 at a position with a low tendency of being heated such as the corners of the print element substrate. Accordingly, in this configuration, as illustrated in FIG. 15C, a time period from a point where the temperature adjustment is started for the region 0 to a point where the temperature of the region 0 reaches the target temperature is longer than that in FIG. 14B.

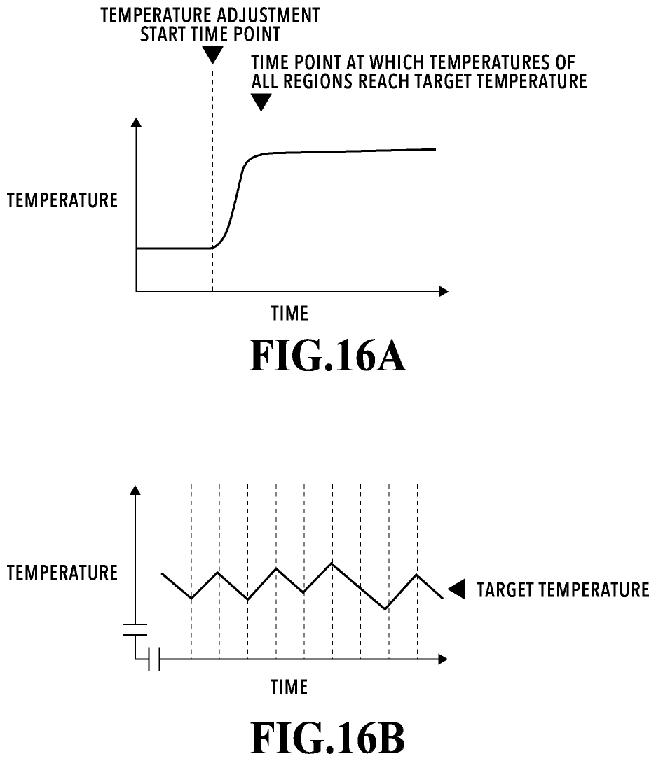

Meanwhile, in the present embodiment, the second table as illustrated in FIG. 12 is prepared to allow appropriate setting of the correction value depending on the difference ΔT between the detected temperature and the target temperature. Accordingly, for example, the table of FIG. 14A is set at the timing of start of the temperature adjustment, and the table of FIG. 15A is set after reaching of the target temperature. FIG. 16A is a graph illustrating a temperature change in each of the divided regions 515 in the present embodiment. FIG. 16B is a graph illustrating a temperature change after the temperature of each divided region 515 reaches the target temperature in the present embodiment.

As illustrated in FIGS. 16A and 16B, a time period from a point where the temperature adjustment is started for each divided region 515 to a point the temperature reaches the target temperature in the present embodiment is about the same as that in the conventional technique (see FIG. 14B). Moreover, after the temperature of each divided region 515 reaches the target temperature, the temperature of each divided region 515 is maintained near the target temperature as illustrated in FIG. 15B.

For example, at a time point immediately after start of the temperature adjustment for the region 0, the actual drive intensity of the sub-heaters 517 provided in the region 0 is determined to be “20”. As a result of driving the sub-heaters 517 provided at a position with a low tendency of being heated at a relatively high drive intensity as described above, the temperature of the corresponding region can be made to reach the target temperature in a relatively-short time period. Then, after the temperature of the region 0 reaches the target temperature (for example, 40° C.), in the technique of the present disclosure, the temporal drive intensity of the sub-heaters 517 provided in the region 0 is reselected.

For example, in the case where the difference ΔT between the temperature of the region 0 and the target temperature after reaching of the target temperature is 0.2° C., “2” is selected as the temporal drive intensity of the sub-heaters 517 provided in the region 0.

Then, the print control unit 203 refers to the second table 1200 (see FIG. 12), and adds the correction value (+1) in the case where the difference ΔT in the region 0 is 0.2° C. to the value representing the temporal drive intensity. As a result, the value of the actual drive intensity of the sub-heaters 517 provided in the region 0 after reaching of the target temperature is determined to be “3”. As described above, in the configuration of the present embodiment, it is possible to achieve both of causing the temperature of the region 0 to reach the target temperature in a relatively-short time period and maintaining the temperature of the region 0 near the target temperature.

Meanwhile, the region 5 is adjacent to the regions 1, 4, 6, and 9. Accordingly, the region 5 receives more heat from the surrounding regions in the case where the temperature adjustment is started than the region 0 adjacent only to the regions 1 and 4. Accordingly, “−2” is defined as the correction value for the sub-heaters 517 provided in the region 5 in the case where the difference ΔT exceeds 2.2 (see FIG. 12). Thus, the actual drive intensity of the sub-heaters 517 provided in the region 5 is determined to be “10” at a time point immediately after start of the temperature adjustment for the region 5.

As described above, in the technique of the present disclosure, as a result of driving the sub-heaters 517 provided at a position with a high tendency of being heated at an appropriate drive intensity, the temperature of the corresponding region can be made to reach the target temperature in about the same time period as the time period necessary for heating the region with a low tendency of being heated. Specifically, in the technique of the present disclosure, regardless of whether the target of heating is at a position with a low tendency of being heated or a position with a high tendency of being heated, the temperature can be made to reach the target temperature in a similar time period. Moreover, after the temperature of the region 5 reaches the target temperature (for example, 40° C.), in the technique of the present disclosure, the temporal drive intensity of the sub-heaters 517 provided in the region 5 is reselected.

For example, in the case where the difference ΔT between the temperature of the region 5 and the target temperature after reaching of the target temperature is 0.2° C., “2” is selected as the temporal drive intensity of the sub-heaters 517 provided in the region 5. Then, the print control unit 203 refers to the second table 1200 (see FIG. 12), and adds the correction value (−1) in the case where the difference ΔT in the region 5 is 0.2° C. to the value representing the temporal drive intensity. As a result, the actual drive intensity of the sub-heaters 517 provided in the region 5 after reaching of the target temperature is determined to be “+1”.

As described above, in the configuration of the present embodiment, the value indicating the actual drive intensity of the sub-heaters 517 provided in the region with many adjacent regions is determined to be smaller than the value indicating the actual drive intensity of the sub-heaters 517 provided in the region with few adjacent regions. As a result, it is possible to cause the temperature of the region 5 to reach the target temperature in a relatively-short time period and maintain the temperature of the region 5 near the target temperature.

In addition, the correction value of each region can be set depending on the difference ΔT between the detected temperature and the target temperature. As a result, appropriate temperature control can be performed for each region in a highly reliable state in the period from start of the temperature adjustment to reaching of the target temperature as well as after reaching of the target temperature.

### <Reduction of Data Volume>

According to the technique of the present disclosure, the volume of data necessary for calculating the actual drive intensity of the sub-heaters 517 can be reduced. This reduction is explained below by using a comparative example.

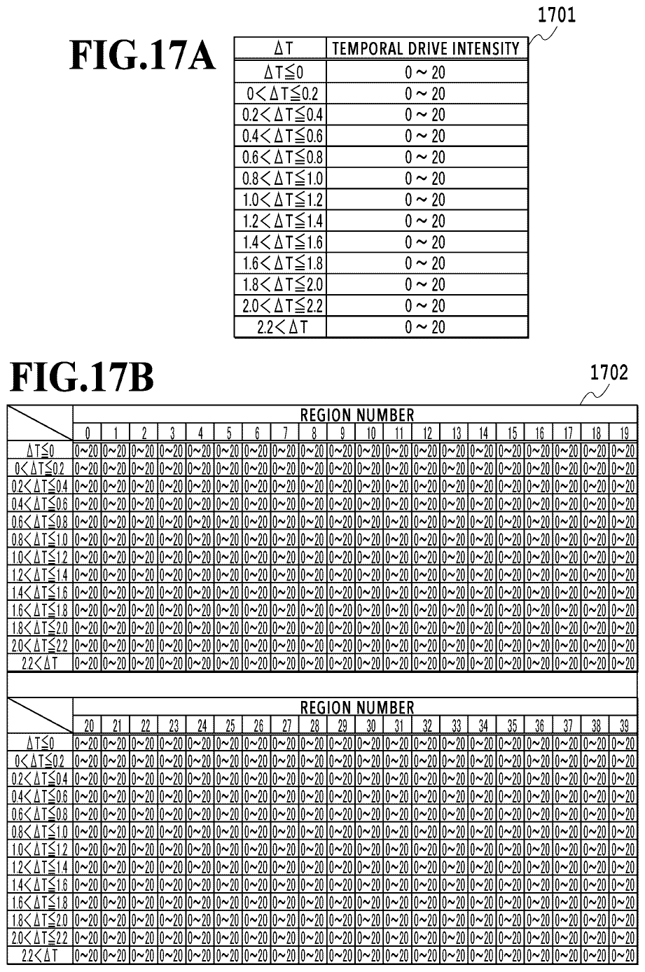

FIG. 17A is a table 1701 used in the case where the temporal drive intensity of the sub-heaters is selected in the comparative example. In this example, the case where the drive intensity is adjustable in 21 levels from 0 to 20 is described. Note that “0 to 20” illustrated in each field indicates that one of values (integers) of “0” to “20” is set.

In the case where the values representing the temporal drive intensity are expressed by integers of 0 to 20 as illustrated in FIG. 17A while using a binary system, 5 bits are necessary for each difference ΔT as a data volume for storing the temporal drive intensity.

In the case where the temporal drive intensity is set for each of the differences ΔT controlled while being divided into 13 levels, 65 bits (5 bits×13 levels) are necessary as the volume of data for selecting the temporal drive intensity of the sub-heaters.

Meanwhile, FIG. 17B illustrates a table 1702 prepared to directly set the actual drive intensity of the sub-heaters based on the position of the divided region and the difference ΔT between the detected temperature and the target temperature without setting of the temporal drive intensity.

As illustrated in FIG. 17B, the print element substrate of the present comparative example is divided into divided regions of region numbers 0 to 39 as in the print element substrate 401 of the present embodiment. Moreover, the actual drive intensity of the sub-heaters is set to one of values (integers) of “0” to “20” for each of these divided regions.

In this case, a table (65 bits) for selecting the temporal drive intensity is unnecessary, but 2,600 bits (5 bits×13 levels×40 regions) are necessary as the volume of data for determining the drive intensity of the sub-heaters provided in all divided regions.

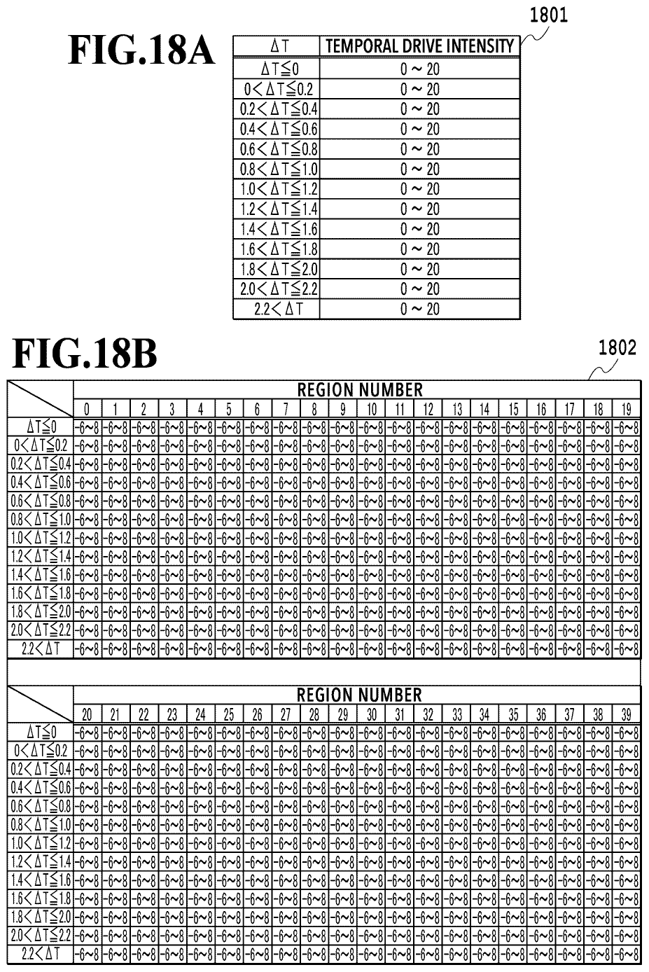

FIG. 18A is a diagram illustrating a table 1801 adoptable to the case where the temporal drive intensity of the sub-heaters 517 is selected in the present embodiment. Note that FIG. 18A illustrates an example in which the temporal drive intensity in the first table 1100 can be adjusted in the range of “0” to “20” as in the above-mentioned comparative example for the convenience of explanation.

In the example of FIG. 11, the temporal drive intensity of the sub-heaters 517 is selected from integers of 0 to 12. However, in this example, as illustrated in FIG. 18A, explanation is given of the case where the temporal drive intensity is selected from integers of 0 to 20 to clarify differences from the comparative example of FIGS. 17A and 17B.

As described above, in the case where the value representing the temporal drive intensity is expressed by 21 types of integers of 0 to 20 by using a binary system, 5 bits are necessary for each difference ΔT as the data volume. Moreover, in this case, 65 bits (5 bits×13 levels) are necessary as the volume of data for selecting the temporal drive intensity of the sub-heaters.

FIG. 18B is a diagram illustrating a table 1802 used in the case where the correction value of the sub-heaters is selected in the present embodiment. Note that FIG. 18B illustrates an example in which the correction value in the second table 1200 is adjusted in a range of “−6” to “8” as in the above-mentioned comparative example for convenience of explanation.

As illustrated in FIG. 18B, in the present embodiment, the correction value of the sub-heaters is expressed by integers in the range of −6 to +8 including 0, depending on the magnitude of the 13 levels of the difference ΔT for each of the 40 divided regions 515. In the case where the correction value is expressed by 15 types of integers of “−6” to “+8” including “0” by using a binary system, 4 bits are necessary as the data volume for each of combinations of the difference ΔT and the divided region.

Accordingly, in the present embodiment, 2,132 bits (5 bits×13 levels+4 bits×13 levels×40 regions) are necessary as the volume of data for selecting the temporal drive intensity of the sub-heaters and determining the actual drive intensity of the sub-heaters. In this case, the data volume can be reduced from that of the table 1702 (2,600 bits) prepared for the case where the actual drive intensity of the sub-heaters is directly obtained based on the position of the divided region and the difference ΔT as in FIG. 17B.

Specifically, each of the multiple regions has a characteristic depending on its position, and the correction value corresponding this characteristic of the position is added to the value representing the temporal drive intensity selected depending on the obtained magnitude of the difference ΔT. As a result, according to the configuration of the present embodiment, the volume of data for determining the actual drive intensity can be reduced from that in the configuration in which the temporal drive intensity obtained depending on the magnitude of the difference ΔT for each of the multiple divided regions is directly adopted as the actual drive intensity. Specifically, according to the technique of the present disclosure, the ROM 302 with a smaller capacity than a ROM used in the comparative example of FIGS. 17A and 17B can be used.

In a form in which the table for determining the temporal drive intensity and the table for determining the correction value are independently prepared as in the present embodiment, contents of each table can be individually rewritten, or a memory can be replaced. Note that, in the present embodiment, each of the parameters in the table for determining the temporal drive intensity and the table for determining the correction value has a range that can be controlled to some extent. Accordingly, frequency of individual rewriting or replacement of memory can be reduced. Specifically, it is possible to reduce the data volume and enable temperature control with high reliability while eliminating need of work of rewriting the contents of the individual tables or the like even in the case where the state of the element substrate or the tendency of being heated for each divided region changes depending on usage environment of the apparatus, age, or the like.

As explained above, according to the configuration of the present embodiment, the temperature value is obtained for each of the multiple divided regions. Then, the difference ΔT between the obtained temperature value and the target temperature value is calculated. Then, the temporal drive intensity of the sub-heaters is selected depending on the magnitude of the difference ΔT. Note that the value representing the temporal drive intensity is defined in advance such that the larger the difference ΔT is, the larger the value is. Then, the table in which the correction value based on the difference ΔT and the region number representing the position of the divided region is defined is referred to.

In the table of the present embodiment, ) for the region with few adjacent regions, the larger the difference ΔT is, the larger the selected correction value is (a correction value that increases the drive intensity is selected).

Meanwhile, for the region with many adjacent regions, the larger the difference ΔT is, the smaller the selected correction value is (a correction value that reduces the drive intensity is selected). Then, adding the correction value selected with reference to the above-mentioned table to the value representing the temporal drive intensity of the sub-heaters causes the value indicating the actual drive intensity of the sub-heaters to be calculated for each of the divided multiple regions. The sub-heaters are driven based on the calculated actual drive intensity. The temperature adjustment using the sub-heaters of the present embodiment is repeated from start of the temperature adjustment to termination of printing. As a result, the temperature of the region can be made to reach the target temperature in a relatively-short time period also in the region with few adjacent regions.

Moreover, the temperature of the region can be suppressed from greatly exceeding the target temperature after reaching the target temperature also in the region with many adjacent regions. Moreover, since the sub-heaters are driven at the drive intensity corresponding the number of adjacent regions after the temperature of the region reaches the target temperature, the temperatures of all divided regions can be maintained near the target temperature.

For example, in the region with many adjacent regions, the actual drive intensity of the sub-heaters is relatively low. Accordingly, the temperature in this region can be suppressed from greatly exceeding the target temperature.

Thus, according to the printing apparatus of the present disclosure, temperature control with high reliability can be performed.

Moreover, according to the printing apparatus of the present disclosure, the volume of data for determining the actual drive intensity of the sub-heater can be also reduced.

### Second Embodiment

In the second table 1200 (see FIG. 12) of the first embodiment, the correction value for each of the multiple divided regions is defined with the number of adjacent regions additionally taken into consideration. However, the method of selectively determining the correction value is not limited to the example of FIG. 12 as long as the tendency of being heated and the tendency of not being heated (tendency of being cooled) of the region to be the target of the temperature control are additionally taken into consideration.

An object of the present embodiment is to provide a method of selectively determining the correction value with the type of flow passage provided in the region to be the target of the temperature control additionally taken into consideration.

Points different from the first embodiment are mainly explained below. Constitutional elements identical or corresponding to those in the first embodiment are denoted by identical reference numerals, and explanation thereof is omitted.

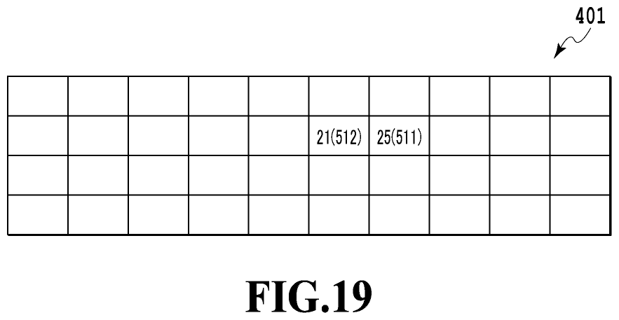

FIG. 19 is a diagram explaining temperature control of the ejection port surface of the print element substrate 401 in the present embodiment.

As illustrated in FIG. 19, in the present embodiment, assume that the collection openings 512 (see FIG. 5C) are formed in the region 21 and the supply openings 511 (see FIG. 5B) are formed in the region 25.

Generally, in the case where the liquid is circulated between the tank (not illustrated) storing the liquid and the print head 101 (see FIG. 1 and the like) configured to eject the liquid, a heat exchanger (chiller) for cooling the liquid is provided between the tank and the print head 101. According to this configuration, excessive heating of the liquid to be supplied to the print head 101 can be suppressed in the configuration in which the liquid is circulated.

In the case where the liquid is circulated, the liquid cooled by the heat exchanger is supplied to the region 25 in which the supply openings 511 are formed.

Note that, in both of the case where the electrothermal transducing elements are used and the case where the electromechanical transducing elements are used, the viscosity of the ink changes depending on the temperature of the ink, and the ejection volume of the ink changes. Accordingly, the circulation is preferably performed also in the case where the electromechanical transducing elements are used.

Although the region 25 has many adjacent regions, the actual drive intensity of the sub-heaters 517 (see FIG. 8B) provided in the region 25 needs to be increased, considering that the region 25 is cooled by the supplied liquid.

Meanwhile, in the region 21 in which the collection openings 512 are formed, the liquid that is heated by the ejection heaters 502 (see FIG. 5B) and the sub-heaters 517 and that is not ejected from the ejection ports 501 (see FIG. 5B and the like) are collected. Accordingly, the actual drive intensity of the sub-heaters 517 provided in the region 21 needs to be reduced, considering that the region 21 has many adjacent regions and the liquid heated by the ejection heaters 502 and the sub-heaters 517 is collected in the region 21.

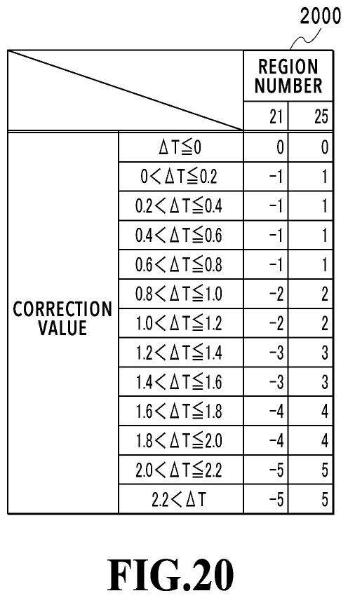

Thus, in the present embodiment, different correction values are prepared for the regions in which the supply openings 511 are formed, the regions in which the collection openings 512 are formed, and the other regions. FIG. 20 is a diagram illustrating an example of a third table 2000 used to select the correction value of the temporal drive intensity in the present embodiment.

FIG. 20 only illustrates the correction value for correcting the temporal drive intensity of the sub-heaters 517 provided in each of the region 21 and the region 25 for convenience of explanation. The correction value illustrated in FIG. 12 can be used for the other regions. Moreover, for example, in the case where an effect of heat from the adjacent regions is sufficiently small, “0” may be set for all differences ΔT for the other regions. Moreover, other values may be set.

As illustrated in FIG. 20, in the region 21, a negative value (value that reduces the drive intensity) is selected as the correction value for correcting the temporal drive intensity of the sub-heaters 517 as the magnitude of the difference ΔT increases.

For example, in the region 21, in the case where the difference ΔT satisfies 0<ΔT≤0.2, the value representing the temporal drive intensity of the sub-heaters 517 is “2” based on the first table. Moreover, the correction value for the temporal drive intensity is “−1” based on the third table. Accordingly, in this case, the actual drive intensity of the sub-heaters 517 provided in the region 21 is determined to be “1=2+(−1)”.

Moreover, in the region 21, in the case where the difference ΔT satisfies 2.2<ΔT, the value representing the temporal drive intensity of the sub-heaters 517 is “12” based on the first table. Furthermore, the correction value of the temporal drive intensity is “−5” based on the third table. Accordingly, in this case, the actual drive intensity of the sub-heaters 517 is determined to be “7=12+(−5)”.

Meanwhile, in the region 25, a positive value (value that increases the drive intensity) is selected as the correction value for correcting the temporal drive intensity of the sub-heaters 517 as the magnitude of the difference ΔT increases.

For example, in the region 25, in the case where the difference ΔT satisfies 0<ΔT≤0.2, the value representing the temporal drive intensity of the sub-heaters 517 is “2” based on the first table. Moreover, the correction value of the temporal drive intensity is “+1” based on the third table. Accordingly, in this case, the actual drive intensity of the sub-heaters 517 is determined to be “3=2+1”.

Moreover, in the region 25, in the case where the difference ΔT satisfies 2.2<ΔT, the temporal drive intensity of the sub-heaters 517 is “12” based on the first table. Furthermore, the correction value of the temporal drive intensity is “+5” based on the third table. Accordingly, in this case, the actual drive intensity of the sub-heaters 517 is determined to be “17=12+5”.

In order to further facilitate understanding of effects of the present embodiment, explanation is given below by describing a comparative example.

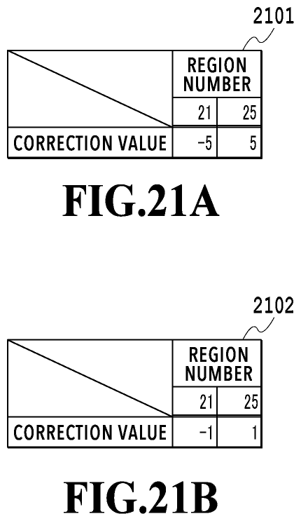

FIG. 21A is a diagram illustrating a table 2101 used to select the correction value of the temporal drive intensity in the comparative example. In the present comparative example, the correction value is assumed to be set based on only the position of the divided region, irrespective of the difference ΔT between the detected temperature and the target temperature. Note that the collection openings 512 are formed in the region 21, and the supply openings 511 are formed in the region 25 also in the present comparative example. Accordingly, the liquid of relatively low temperature is supplied to the region 25, and the liquid of relatively high temperature is collected from the region 21.

As illustrated in FIG. 21A, the correction value for correcting the temporal drive intensity of the sub-heaters provided in each of the region 21 and the region 25 are defined in advance in the table 2101.

In the table 2101, the correction value adoptable to the time period from start of the temperature adjustment to reaching of the target temperature is defined. Accordingly, the table 2101 is identical to the contents of the row of “2.2<ΔT” in the third table 2000 illustrated in FIG. 20.

However, in this configuration, “+5” is maintained as the correction value of the temporal drive intensity of the sub-heaters also after the temperature of the region 25 reaches the target temperature. Specifically, in the region 25 of the present comparative example, maintaining the temperature near the target temperature is difficult after the temperature reaches the target temperature, and there is a possibility that the temperature greatly exceeds the target temperature.

FIG. 21B is a diagram illustrating a table 2102 used to select the correction value of the temporal drive intensity in another comparative example. Also in the present comparative example, the collection openings 512 are formed in the region 21, and the supply openings 511 are formed in the region 25. Accordingly, the liquid of relatively low temperature is supplied to the region 25, and the liquid of relatively high temperature is collected from the region 21.

As illustrated in FIG. 21B, the correction value for correcting the temporal drive intensity of the sub-heaters provided in each of the region 21 and the region 25 are defined in advance in the table 2102. In the table 2102, the correction value suitable for maintaining the target temperature is defined. The table 2102 is identical to the contents of the row of “0<ΔT≤0.2” in the third table 2000 illustrated in FIG. 20.

However, in this configuration the correction value for the region 25 is too small at the timing of start of the temperature adjustment. Accordingly, in this configuration, the time period from the point where the temperature adjustment of the region 25 is started to the point where the temperature of the region 25 reaches the target temperature is long.

As explained above, according to the configuration of the present embodiment, the actual drive intensity of the sub-heaters 517 provided in the region 25 to which the liquid of relatively low temperature is supplied can be made higher than the actual drive intensity of the sub-heaters 517 provided in the region 21 to which the liquid of relatively high temperature is supplied. Note that the correction values illustrated in FIG. 20 are examples. It is important that, in the case where the difference ΔT is larger than a third value (0 in the present configuration), the correction value of the sub-heaters provided in the region 25 in which the supply openings 511 are formed is set to a value larger than the correction value of the sub-heaters provided in the region 21 in which the collection openings 512 are formed.

Accordingly, the time period from start of the temperature adjustment to reaching of the target temperature can be made relatively short also in the region 25 having such a characteristic that the region has many adjustment regions but has a low tendency of being heated.

Moreover, the actual drive intensity of the sub-heaters 517 provided in the region 21 to which the liquid of relatively high temperature is discharged can be made lower than the actual drive intensity of the sub-heaters 517 provided in the region 21 to which the liquid of relatively low temperature is supplied.

Accordingly, the temperature of the region 21 having the characteristic of a high tendency of being heated can be maintained near the target temperature after reaching the target temperature. Note that, even if the temperature of the region 21 exceeds the target temperature, the temperature is suppressed from greatly exceeding the target temperature.

In the present embodiment, the difference ΔT is calculated, and the temporal drive intensity and the correction value are selected for each region. However, the temporal drive intensity and the correction value may be directly selected based on a temperature measured with a sensor. In FIG. 11, the temporal drive intensity is selectable for each ΔT such as ΔT≤0, 0<ΔT≤0.2, 0.2<ΔT≤0.4, and the like. However, the temporal drive intensity or the correction value may be selectable for each temperature detected by the sensor such as T≤40.0, 39.8≤T<40.0, 39.6<T≤39.8, and the like.

### Other Embodiments

Although the inks are used as the liquids in the above-mentioned embodiments, the liquids that can be used in the technique of the present disclosure are not limited to the inks. Various printing liquids including processing liquids and the like used to improve fixability of the inks on the print medium, reduce glossy unevenness, and improve scratch resistance can be used as the liquids in addition to the inks.

In the above explanation, explanation is given assuming that the printing apparatus is an inkjet printer using an inkjet printing method. However, the printing apparatus may be, for example, a single-function printer having only a printing function or a multi-function printer having multiple functions such as the printing function, a facsimile function, and a scanner function. Alternatively, the printing apparatus may be a manufacturing apparatus for manufacturing a color filter, an electronic device, an optical device, a microstructure, or the like in a predetermined printing method.

In the above-mentioned embodiment, the first table 1100 (see FIG. 11) is used to determine the temporal drive intensity. However, the temporal drive intensity can be determined without using the first table 1100. For example, the temporal drive intensity can be determined by using the following linear formula.

$$x = a * Δ T + b \qquad ( Formula 1 )$$

In this formula, x is the temporal drive intensity, ΔT is the difference between the detected temperature and the target temperature, and a and b are predetermined constants.

In the above-mentioned embodiment, the second table 1200 (see FIG. 12) is used to determine the correction value of the temporal drive intensity. However, the correction value of the temporal drive intensity can be determined without using the second table 1200.

$$y = c * Δ T + d ( region number 0 ) \qquad ( Formula 2 )$$

$$y = {c}^{′} * Δ T + {d}^{′} ( region number 1 ) \qquad ( Formula 3 )$$

In these formulae, y is the correction value, ΔT is the difference between the detected temperature and the target temperature, c and d are predetermined constants specific to the region 0, and c′ and d′ are predetermined constants specific to the region 1.

The correction value of the temporal drive intensity may be calculated by using a calculation formula in which the difference ΔT is multiplied by a threshold, and a value representing the region number is added to a resultant value. Moreover, a quadratic function, an exponential function, and the like may be used in addition to the linear function.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the printing apparatus of the present disclosure, temperature control with high reliability can be performed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034515, filed Mar. 5, 2025, which is hereby incorporated by reference herein in its entirety.

What is claimed is:

1. A printing apparatus comprising an element substrate provided with a print element array formed of a plurality of print elements configured to eject a liquid to a print medium, heating elements configured to heat the liquid, and sensors configured to detect temperatures, wherein
at least one of the heating elements and at least one of the sensors are provided in each of a plurality of divided regions obtained by dividing the element substrate into a plurality of regions,
the printing apparatus further comprises:
a first determination unit configured to determine a first drive intensity for the heating element based on the temperature detected by the sensor for each of the divided regions;
a second determination unit configured to determine a correction value for correcting the first drive intensity for each of the divided regions;
a third determination unit configured to determine a second drive intensity by correcting the first drive intensity based on the correction value for each of the divided regions; and
a drive unit configured to drive the heating element according to the second drive intensity for each of the divided regions, and
the second determination unit determines the correction value based on the temperature and a position of each of the divided regions.

2. The printing apparatus according to claim 1, wherein the first determination unit determines the first drive intensity for the heating element based on a difference obtained by subtracting the temperature detected by the sensor from a target temperature for each of the divided regions.

3. The printing apparatus according to claim 1, wherein the drive unit changes a pulse width for driving the heating element, depending on the second drive intensity.

4. The printing apparatus according to claim 1, wherein types of values selectable as the correction value are fewer than types of values selectable as the first drive intensity.

5. The printing apparatus according to claim 2, wherein
in a case where the difference is a first value, the first determination unit determines a value representing the first drive intensity to be a value indicating no drive of the heating element, and
in a case where the difference is a second value larger than the first value, the first determination unit determines the value representing the first drive intensity to be a value indicating drive of the heating element.

6. The printing apparatus according to claim 5, wherein
in the case where the difference is the first value, the second determination unit determines the correction value to be a value indicating no correction of the first drive intensity, and
in the case where the difference is the second value, the second determination unit determines the correction value for the divided region located at a corner of the element substrate to be a value that increases the first drive intensity.

7. The printing apparatus according to claim 6, wherein, in the case where the difference is the second value, the second determination unit determines the correction value for the divided region located in a center portion of the element substrate to be a value that reduces the first drive intensity.

8. The printing apparatus according to claim 7, wherein, in the case where the difference is the second value, the second determination unit determines the correction value for the divided region located in an end portion of the element substrate to be a value between the correction value for the divided region located at the corner of the element substrate and the correction value for the divided region located in the center portion of the element substrate.

9. The printing apparatus according to claim 5, wherein an absolute value of the correction value determined by the second determination unit in the case where the difference is the first value is equal to or smaller than an absolute value of the correction value determined by the second determination unit in the case where the difference is the second value.

10. The printing apparatus according to claim 2, wherein the divided regions include a first region and a second region that has more adjacent regions than the first region.

11. The printing apparatus according to claim 10, wherein the correction value determined by the second determination unit for the first region in a case where the difference in the first region and the difference in the second region are the same is equal to or larger than the correction value determined by the second determination unit for the second region in a case where the difference in the first region and the difference in the second region are the same.

12. The printing apparatus according to claim 2, further comprising:
a tank configured to store the liquid;
a print head including the element substrate; and
a circulation unit configured to circulate the liquid between the tank and the print head, wherein
the element substrate includes a supply opening for supplying the liquid from the tank and a collection opening for collecting the liquid into the tank, and
in a case where the difference is larger than a third value, the correction value determined by the second determination unit for the divided region in which the supply opening is formed among the plurality of divided regions is a value larger than the correction value determined by the second determination unit for the divided region in which the collection opening is formed.

13. The printing apparatus according to claim 2, wherein the first determination unit determines the first drive intensity for each of the plurality of divided regions by referring to a table in which the difference and the first drive intensity are associated with each other.

14. The printing apparatus according to claim 2, wherein the second determination unit determines the correction value for each of the plurality of divided regions by referring to a table in which a position of the divided region in the element substrate, the difference, and the correction value are associated with one another.

15. A control method of a printing apparatus including an element substrate provided with a print element array formed of a plurality of print elements configured to eject a liquid to a print medium, heating elements configured to heat the liquid, and sensors configured to detect temperatures, wherein
at least one of the heating elements and at least one of the sensors are provided in each of a plurality of divided regions obtained by dividing the element substrate into a plurality of regions,
the control method comprises:
determining a first drive intensity for the heating element based on the temperature detected by the sensor for each of the divided regions;
determining a correction value for correcting the first drive intensity for each of the divided regions; and
determining a second drive intensity by correcting the first drive intensity based on the correction value for each of the divided regions; and
causing a drive unit to drive the heating element according to the second drive intensity for each of the divided regions, and
the correction value is determined based on the temperature and a position of each of the divided regions.

16. The control method according to claim 15, wherein the first drive intensity for the heating element is determined based on a difference obtained by subtracting the temperature detected by the sensor from a target temperature for each of the divided regions.

17. The control method according to claim 15, wherein the drive unit changes a pulse width for driving the heating element, depending on the second drive intensity.

18. The control method according to claim 15, wherein types of values selectable as the correction value are fewer than types of values selectable as the first drive intensity.

19. The control method according to claim 16, wherein
in a case where the difference is a first value, a value representing the first drive intensity is determined to be a value indicating no drive of the heating element, and
in a case where the difference is a second value larger than the first value, the value representing the first drive intensity is determined to be a value indicating drive of the heating element.

20. The control method according to claim 19, wherein
in the case where the difference is the first value, the correction value is determined to be a value indicating no correction of the first drive intensity, and
in the case where the difference is the second value, the correction value for the divided region located at a corner of the element substrate is determined to be a value that increases the first drive intensity.

21. The control method according to claim 20, wherein, in the case where the difference is the second value, the correction value for the divided region located in a center portion of the element substrate is determined to be a value that reduces the first drive intensity.

22. The control method according to claim 21, wherein, in the case where the difference is the second value, the correction value for the divided region located in an end portion of the element substrate is determined to be a value between the correction value for the divided region located at the corner of the element substrate and the correction value for the divided region located in the center portion of the element substrate.

23. The control method according to claim 19, wherein an absolute value of the correction value in the case where the difference is the first value is equal to or smaller than an absolute value of the correction value determined in the case where the difference is the second value.

24. The control method according to claim 16, wherein the divided regions include a first region and a second region that has more adjacent regions than the first region.

25. The control method according to claim 24, wherein the correction value determined for the first region is equal to or larger than the correction value determined for the second region in a case where the difference in the first region and the difference in the second region are the same.

26. The control method according to claim 16, wherein
the printing apparatus further includes:
a tank configured to store the liquid;
a print head including the element substrate; and
a circulation unit configured to circulate the liquid between the tank and the print head,
the element substrate includes a supply opening for supplying the liquid from the tank and a collection opening for collecting the liquid into the tank, and
in a case where the difference is larger than a third value, the correction value determined for the divided region in which the supply opening is formed among the plurality of divided regions is a value larger than the correction value determined for the divided region in which the collection opening is formed.

27. The control method according to claim 16, wherein the first drive intensity is determined for each of the plurality of divided regions by referring to a table in which the difference and the first drive intensity are associated with each other.

28. The control method according to claim 16, wherein the correction value is determined for each of the plurality of divided regions by referring to a table in which a position of the divided region in the element substrate, the difference, and the correction value are associated with one another.
